(19) United States
(12) Patent Application Publication
(10) Pub. No.: US 2022/0241131 A1
(43) Pub. Date: Aug. 4, 2022

(54) PULLEY SYSTEM FOR REMOTELY MOUNTED EXOSKELETON ACTUATORS

(71) Applicant: X Development LLC, Mountain View, CA (US)

(72) Inventors: Antonio Raymond Papania-Davis, Oakland, CA (US); Maxwell Keith Shepherd, Charlottesville, VA (US)

(21) Appl. No.: 17/163,207

(22) Filed: Jan. 29, 2021

(51) Int. Cl. A61H 3/00; F16H 19/06; A61H 1/02

(52) U.S. Cl. CPC A61H 3/00; F16H 19/0672; F16H 19/0645; A61H 1/0266; A61H 2201/1207; A61H 2003/007; A61H 2201/165; A61H 2201/149; F16H 2019/0695

(57) ABSTRACT

This application relates to an actuation system for assistive wearable devices such as exoskeletons designed to actuate a joint of a wearer of the device. The actuation system comprises a cable that connects a guide member arranged on one side of the joint and active components arranged on the other side of the joint. Applying a tension to the cable causes the cable to apply a force to the joint in a superior direction, which translates into a torque of the joint. The actuation system provides the advantages of having a low profile, and being substantially flexible, compliant, lightweight, and comfortable, while having good controllability and force delivery capabilities.

### TECHNICAL FIELD

This disclosure relates to actuation systems for assistive wearable devices such as exoskeletons.

### BACKGROUND

Exoskeletons are wearable devices that are typically designed to assist a wearer with movement, for example, by providing force, stability, and balance to supplement a wearer's own capabilities. Exoskeletons can enhance the function of different joints in the body, such as an ankle, a knee, or an elbow. For example, an exoskeleton can include an actuator configured to transmit torque to the joint in order to actuate it.

### SUMMARY

This specification describes actuation systems for exoskeletons and other assistive devices, including actuation systems that use cables to selectively apply force to actuate a joint of a wearer's body. The actuation system can include a motor configured to be placed at one side of the joint, a pulley or other guide member to be placed at the other side of the joint, and a cable that extends around the guide member to form a loop. The two sides of the loop extend across the joint from the guide member up to the upper attachment portion where the motor is located. By engaging the motor to either draw in or release cable on a spool, the actuation system can adjust the tension in the cable loop and consequently the force pulling up on the guide portion. This arrangement can be used to provide actuation for an ankle, knee, elbow or other joint.

One of the advantages of the cable-based actuation system is that it can use the joint of the wearer's body without a separate, artificial joint that can interfere with or restrict natural movement of the patient's joint. For example, when used with an ankle, the guide member can be a pulley coupled to the back of the wearer's foot, so that winding cable around a spool at the upper portion of the system pulls up on the back of the foot. In this case, the wearer's biological joint, the ankle, is actuated and no bulky or restrictive components hinder other natural movement of the ankle. In this case, the motor, battery, control electronics, sensors, and other components can be placed at the upper shin, while the pulley is coupled to a wearer's shoe or a lightweight and potentially even a flexible insert or frame around the foot. This places most of the mass of the actuation system, and especially the heaviest components such as the motor assembly, relatively high on the body (e.g., less distal). This provides good metabolic efficiency and comfort, since efficiency is heavily penalized by mass the further down the leg it goes. Also, the two ends of the cable loop, having two points of connection to the attachment portion on the wearer's shin, help distribute the forces on the leg, avoiding an uncomfortably high force on the user's shin as force is applied to the foot through the cable loop. Because there are two ends of the cable, and the force between the upper attachment portion carrying the motor and the foot is split equally along the two sides of the cable loop. To reach the connection points at the upper attachment portion at the shin, the cable strands can lie along and the medial and lateral sides of the wearer's leg, potentially in a sheath or integrated into clothing.

Maintaining a low physical profile, weight, and complexity, while maximizing force delivery capabilities, is a primary concern for exoskeleton design. Additionally, there are challenges related to robot-human coordination tolerance: an actuator must be able to accurately and smoothly provide torques to the wearer to perform both positive and negative mechanical work. Many conventional exoskeletons feature mechanical systems that are bulky, heavy, difficult to use, and often require artificial joint components in addition to the biological joints in order to assist with the desired plane of movement. For example, current cable-based actuation strategies require compression sheaths and rigid structures alongside the cables to maintain compressive reaction forces, which add increased nonlinear effects in the force transmission and decrease controllability. Additionally, cable-based actuators require the full weight of the cable to be suspended by other parts of the body, which limits the amount of force that can be transmitted safely and comfortably. Furthermore, currently known solutions restrict the freedom of movement of the joint in directions other than the direction in which the joint is being actuated. For example, mechanically applying ankle flexion restricts inversion/eversion and internal/external rotation of the foot.

The exoskeleton actuators discussed herein overcome the aforementioned drawbacks of many conventional actuators. Specifically, it provides the advantages of having a low profile, and being substantially flexible, compliant, lightweight, and comfortable, while having good controllability and force delivery capabilities. In addition, the exoskeleton actuators discussed herein provide the ability to effectively assist natural movements of the wearer's body without unduly restricting other natural movements of joints. For example, by coupling an actuator to a patient's foot through a pulley or other guide member at the foot, the system can induce plantarflexion and/or dorsiflexion (e.g., flexion and extension of the ankle) without restricting inversion and eversion (e.g., side-to-side movements that roll the sole of the foot medially and laterally) and without restricting medial and lateral rotation of the ankle (e.g., internal rotation and external rotation). This allows the assistive force provided by the actuator to be targeted for movement in specific directions or planes, preserving the wearer's ability to make other fine movements in other directions and planes that may be needed for balance and efficient movement.

According to a first aspect there is provided an assistive device configured to assist actuation of a joint of a body of a wearer of the assistive device. The assistive device has a first attachment portion configured to be placed on a first portion of the wearer's body and a guide member coupled to the first attachment portion. The assistive device also has a second attachment portion configured to be placed on a second portion of the wearer's body and a motor coupled to the second attachment portion. Further, the assistive device has a cable that is coupled to the second attachment portion at two locations. The cable extends to the guide member and forms a loop around the guide member. The motor is configured to increase tension in the cable such that the loop of the cable pulls the first attachment portion toward the second attachment portion to actuate the joint.

According to a second aspect there is provided an assistive device configured to assist actuation of an ankle of a wearer of the assistive device. The assistive device has a lower attachment portion configured to be coupled with a foot of the wearer and a pulley coupled to the lower attachment portion. The assistive device also has an upper attachment portion configured to be placed on a leg of the wearer and a motor coupled to the upper attachment portion. Further, the assistive device has a cable that is coupled to the upper attachment portion at two locations. The cable extends around the pulley to form a loop around the pulley. The motor is configured to increase tension in the cable such that the loop of the cable pulls the lower attachment portion toward the upper attachment portion to actuate the ankle.

Particular implementations of the subject matter described in this disclosure can be implemented so as to realize, but are not limited to, one or more of the following advantages. For example, the wearable device can have a low profile, and being substantially flexible, compliant, lightweight, and comfortable, while maintaining the ability to effectively assist with natural movements of the wearer's body without unduly restricting them. Further, the device may use the biological joint without the need for any artificial joints (e.g., hinges integrated as part of the overall mechanical system.

In one general aspect, an assistive device is configured to assist actuation of a joint of a body of a wearer of the assistive device. The assistive device includes a first attachment portion configured to be placed on a first portion of the wearer's body; a guide member coupled to the first attachment portion; a second attachment portion configured to be placed on a second portion of the wearer's body; a motor coupled to the second attachment portion; and a cable that is coupled to the second attachment portion at two locations on the second attachment portion, the cable extending to the guide member and forming a loop around the guide member, the motor being configured to increase tension in the cable such that the loop of the cable pulls the first attachment portion toward the second attachment portion to actuate the joint.

In some implementations, the assistive device is an exoskeleton.

In some implementations, the assistive device is integrated into clothing.

In some implementations, the guide member is a pulley.

In some implementations, the pulley has an axis of rotation that is substantially perpendicular to an axis of rotation of the joint.

In some implementations, the guide member comprises a channel or groove and the cable is configured to slide through the channel or groove.

In some implementations, the guide member is a rounded element that the cable is configured to slide along.

In some implementations, the loop of the cable is substantially V-shaped.

In some implementations, the assistive device includes a spring coupled to the cable, the cable being coupled to the second attachment portion through the spring.

In some implementations, the assistive device includes a load sensor coupled to the cable, the cable being coupled to the second attachment portion through the load sensor.

In some implementations, the assistive device includes a spool coupled to the motor, the spool being configured to receive and release a portion of the cable in response to the operation of the motor.

In some implementations, the assistive device includes a position encoder configured to determine a position of the motor or a component coupled to the motor.

In some implementations, the assistive device includes the assistive device is configured to actuate an ankle of the wearer.

In some implementations, the assistive device includes the assistive device is configured to actuate a knee of the wearer.

In some implementations, the assistive device includes the assistive device is configured to actuate an elbow of the wearer.

In some implementations, the assistive device is configured to actuate a knee joint of the wearer.

In some implementations, the two locations on the second attachment portion are on opposite sides of the second portion of the body, and wherein a first location of the two locations is on the medial side of the second portion of the body and a second location of the two locations is on the lateral side of the second portion of the body.

In some implementations, the first attachment portion and the second attachment portion are configured to be placed on opposite sides of the joint.

In some implementations, the assistive device includes a second guide member coupled to the first attachment portion, and wherein the cable extends from the first guide member to the second guide member and forms a loop around the second guide member.

In another general aspect, an assistive device configured to assist actuation of an ankle of a wearer of the assistive device. The assistive device includes a lower attachment portion configured to be coupled with a foot of the wearer; a pulley coupled to the lower attachment portion; an upper attachment portion configured to be placed on a leg of the wearer; a motor coupled to the upper attachment portion; and a cable that is coupled to the upper attachment portion at two locations on the upper attachment portion, the cable extending around the pulley to form a loop around the pulley, the motor being configured to increase tension in the cable such that the loop of the cable pulls the lower attachment portion toward the upper attachment portion to actuate the ankle.

In some implementations, the upper attachment portion is configured to be placed on the leg below the knee.

In some implementations, the two locations on the upper attachment portion are on opposite sides of the leg, and wherein a first location of the two locations is on the medial side of the leg and a second location of the two locations is on the lateral side of the leg.

In some implementations, the cable is configured to exert a force on the lower attachment portion in a substantially superior direction, such that the ankle is flexed without restricting inversion and eversion of the foot.

In some implementations, the cable is configured to exert a force on the lower attachment portion in a substantially superior direction, such that the ankle is flexed without restricting medial and lateral rotation of the ankle.

In some implementations, the assistive device includes a second pulley coupled to the lower attachment portion, and wherein the cable extends from the first pulley to the second pulley and forms a loop around the second pulley.

The details of one or more implementations are set forth in the accompanying drawings and the description. Other features, aspects, and advantages of the subject matter will become apparent from the description, the drawings, and the claims.

### BRIEF DESCRIPTION OF THE DRAWINGS

FIG. 1 illustrates a human wearing an example exoskeleton actuator.

FIG. 2A illustrates the medial view of an example ankle joint exoskeleton actuator.

FIG. 2B illustrates the rear view of an example ankle joint exoskeleton actuator.

FIG. 2C illustrates the lateral view of an example ankle joint exoskeleton actuator.

FIG. 3A illustrates a rest position of the ankle joint with an example ankle joint exoskeleton actuator.

FIG. 3B illustrates the actuation of the ankle joint by an example ankle joint exoskeleton actuator.

FIG. 4A illustrates the medial view of an example ankle joint exoskeleton actuator.

FIG. 4B illustrates the rear view of an example ankle joint exoskeleton actuator.

FIG. 4C illustrates the lateral view of an example ankle joint exoskeleton actuator.

FIG. 5A illustrates the medial view of an example knee joint exoskeleton actuator.

FIG. 5B illustrates the rear view of an example knee joint exoskeleton actuator.

FIG. 5C illustrates the lateral view of an example knee joint exoskeleton actuator.

FIG. 6 illustrates the lateral view of an example flexure exoskeleton actuator.

FIG. 7 illustrates the lateral view of an example flexure exoskeleton actuator.

Like reference numbers and designations in the various drawings indicate like elements.

### DETAILED DESCRIPTION

Wearable assistive devices such as exoskeletons are often rigid, heavy and involve custom actuation strategies—this generally adds to their cost and difficulty of use. Common exoskeletons often transmit force directly through mechanically powered joints (e.g., hinges) redundant to joints in the human body contributing to bulk and weight. More recently soft exoskeleton approaches have utilized push/pull tendon based systems to reduce the size of the mechanical system. That said, neither of these systems currently achieve a low profile, simplicity, and effective actuation simultaneously. As described in more detail below, the present techniques provide a flexible and compliant cable-based exoskeleton actuator that minimizes the size of the mechanism and restrictions to natural range of movement of bodily joints while maintaining the ability to deliver high torques across joints with good controllability.

Maintaining a low physical profile, weight, and complexity while maximizing force delivery capabilities is a primary concern for exoskeleton design. Additionally there are challenges related to robot human coordination error tolerance. A mechanical system must be able to either very accurately control the joint angle and position of the articulating components or be compliant if they are not perfectly aligned. This holds true in not only effectively assisting a human with the desired plane of movement, but also not unduly restricting other axes of joint rotation. A Series Elastic Actuator (SEA) architecture has been shown to improve force controllability in other designs, and low-level control (e.g., accurately producing the torque that is desired) is a greater challenge in designing new wearables of other types. That said, current SEA solutions often come at the cost of high weight and complexity. Cable-based systems can be used in SEA configurations, improving force control and allowing large transfer of mechanical work, but have challenges. Cable-based actuation strategies have traditionally required (1) compression sheaths (Bowden Cable), which adds increased nonlinear effects in the transmission and decreases controllability, (2) rigid structures alongside the cables to maintain compressive reaction forces, and/or (3) the full weight of the cable to be suspended by other parts of the body, which limits the amount of force that can be transmitted safely and comfortably.

Various examples below show cable-based architectures that allow unidirectional torque application through a system that uses a cable loop around a guide member, such as a pulley. A local rigid or semi-rigid orthosis efficiently converts large deflection and low force work by the cable into a torque to actuate a wearer's joint. The actuator, when worn, can provide a substantially triangular loop of cable that extends from a motor across a joint of a wearer to a pulley, and then back across the joint. The cable loop can form a V-shape with the point of the V being provided by the pulley. The portion of the cable extending from the motor can wrap on and off a spool and position encoder associated with the motor. The other side of the V-shaped loop can be coupled with a spring and force sensor to aid in actuator control to form a series elastic actuator (SEA). The spring is optional, however, and the device can be formed and used effectively without a series compliant element.

In some implementations, the pulley is placed at a lower portion of the body, such as the lower leg for actuating the knee or at the heel, ankle, or foot for actuating the ankle. The pulley can be positioned to be aligned so that it lays flat along or even against the body, thus maintaining a low profile. The cable can be housed in clothing, for example, integrated non-structural sleeves or protective tubing to avoid the cable snagging on objects as the wearer moves. A single pulley can be used on the lower mount with a single loop of cable. As another option, multiple pulleys can be located at the lower mount, each with a loop of cable passing along the pulley. A load cell can also be used to facilitate better control and increased torque application.

As discussed further below, the arrangement of components for the cable-based actuator has several advantages. For example, the active components handling power and data (e.g., the motor and load cell) are all on one side of the joint, typically at or near the upper mount area that attaches to the wearer's body. At the lower mount, the design can include very few and very light components, such as the passive pulley to carry the cable. By placing the majority of the components and the heaviest components (e.g., batteries, motors, etc.) above the joint closer to the center of the body, this arrangement reduces distal mass, which has larger penalties to metabolic cost of transport than proximal mass.

In addition, the use of a pulley on the far side of the joint halves the amount of torque that is required to be produced by the motor, although it doubles the speed of the motor. This tradeoff that reduces the amount of gear reduction needed by the rest of the actuator. Due to the loop format of the cable, the joint can move freely out of the main plane of actuation with minimal or no restriction. For example, when implemented for an ankle, ankle flexion (e.g., pitch) can be applied lifting the heel, while not affecting the foot's ability to move freely in the yaw and roll axes (e.g., inversion, pronation).

As another advantage, the cable can be easily kept taught with minimal active intervention given the free floating nature of the lower pulley. In its most basic form, the technique can be single acting, such as actively inducing plantarflexion (e.g., applying force pulling up at the heel of the foot to move the foot down) without any component to impel dorsiflexion (e.g., with no force to pull the move the foot upward). However, dual-acting configurations can be provided by mirroring the device on both sides (e.g., front and back). For example, for an ankle, both dorsiflexion and plantarflexion can be provided using a pulley and cable loop at the back of the foot (e.g., heel) as well as a pulley and cable loop at the front of the foot (e.g., at the top of the foot). In some implementations, a single motor can be used for both actions, so the same motor achieves double acting function by turning the spool in different directions. In joints with a small degree of flexion, such as the ankle, this method can be used directly. In joints with a greater degree of flexion, such as the elbow or knee, an additional floating guide plate can be used, for example, to capture the cables and keep them on the front of the knee in a flexed position. This guide plate can employ additional pulleys, a tube or channel for passage of cable or even a Bowden cable, and can be integrated into clothing if desired. In these cases, the motor, spring, and load cell would be placed on the sides of the limb perpendicular to the plane of the pulley placed on the back of the limb (e.g., the plane in which the pulley rotates, which is perpendicular to the axis of rotation of the pulley).

Implementations can use different strategies for force transfer to the body depending on the joint to be actuated. Examples include (1) fully suspended and independent, (2) half suspended and half supported, and (3) fully supported. In the fully-suspended version, the cable, potentially with a protective sheath or covering, is the only mechanical element of the actuator that travels across the joint. The upper mount or attachment portion of the exoskeleton with both ends of the “V” depend on friction against the skin and normal force to resist the actuator sliding down the limb. This strategy may be appropriate for relatively low-power ankle applications and configurations where large surface areas can be employed on the full leg or arm, allowing for secure attachment as well as comfort to the wearer.

The half-suspended and half-supported version can involve one side of the cable V being attached to a suspended cuff while the other is attached to a hinged compression element that mirrors the human joint. While this method adds complexity, it also effectively halves (or reduces by even more, depending on number of pulleys used) the load placed on the suspended cuff and compression element. This allows for more mechanical work to be delivered with less force on the cable, and thus less shear of soft tissue and axial compression of the bone. This configuration would also allow for a cable and optionally a sheath to originate from a location remote from the joint in question. For example, an ankle joint could be powered by motors mounted on the thigh or waist allowing for more configuration flexibility and less distal mass.

The fully-supported version can be one in which at the upper mount or attachment portion, both the motor and load cell sides of the V are attached to a redundant compression structure that mirrors the human joint and bares the full compressive load. This version does not provide the weight and complexity saving of the other versions, but compressive load transfer will be consistent no matter how well the actuator is anchored to the body as there will effectively be no sheer force between the actuator and body.

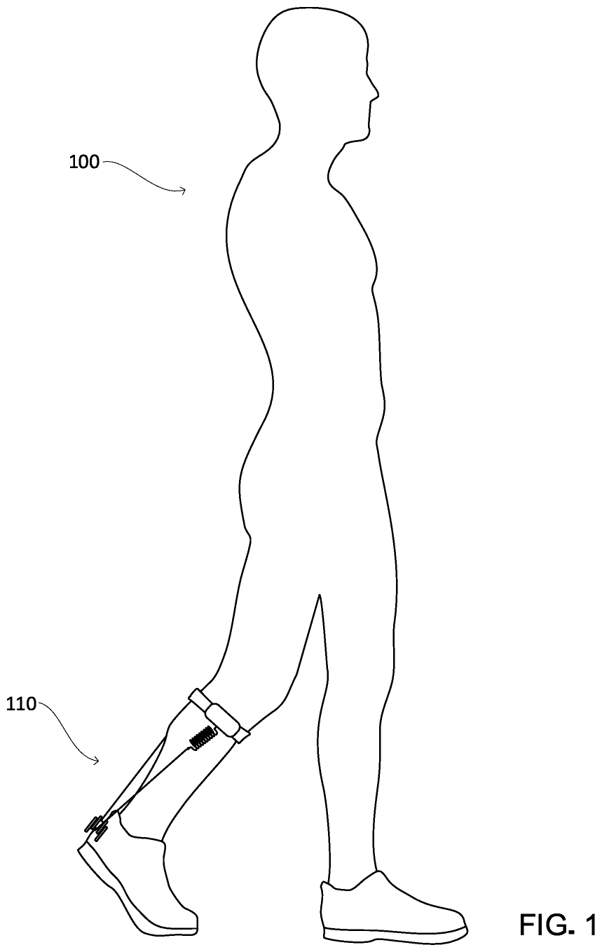

FIG. 1 shows a human 100 wearing an example assistive device, an exoskeleton actuator 110 in this example. The actuator 110 may be worn on the lower limb in order to assist the wearer 100 with the actuation of the ankle joint during walking. For example, the actuator 110 may deliver torque to the ankle joint to induce plantar flexion of the foot (extension of the ankle) at each step. While the actuator 110 in FIG. 1 is shown as being worn on the lower limb, the actuator may be applicable to other joints of the body such as, but not limited to, an elbow joint. The components of the exoskeleton actuator 110 are described in more detail below.

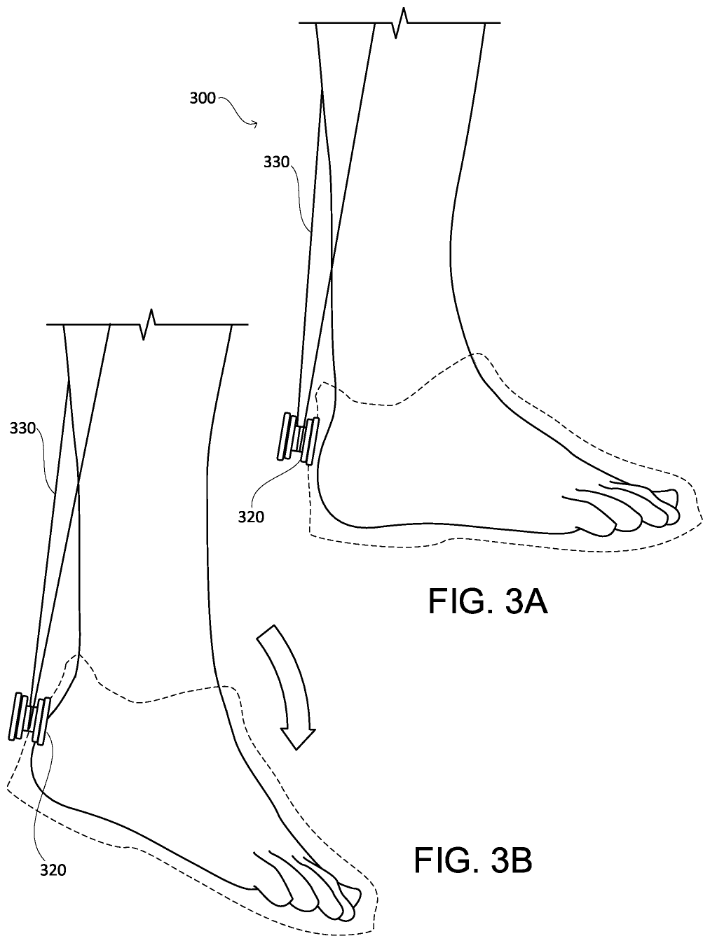

The actuator 110 may include a guide member, such as a pulley, coupled to a first attachment portion which may be placed on the wearer's body at the back of the ankle. The pulley may function together with the other components of the exoskeleton actuator 110 to provide the force to actuate the ankle joint in such a way that the freedom of movement of the joint in other directions is preserved. For example, by using the pulley, ankle plantar flexion can be applied lifting the heel while not affecting the foot ability to move freely in the yah and roll axis. The range of motion of the ankle will be described in more detail below with reference to FIGS. 3A and 3B.

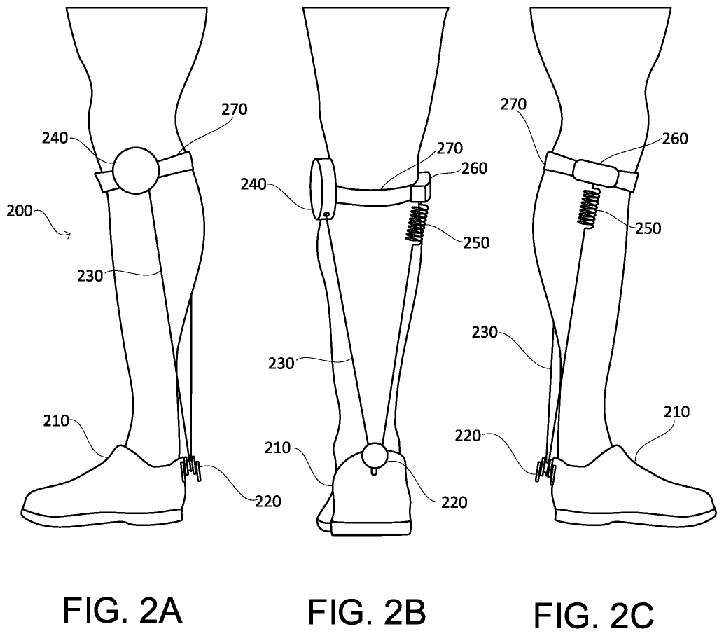

FIGS. 2A, 2B and 2C show medial, rear, and lateral views, respectively, of an example ankle joint exoskeleton actuator 200. The actuator 200 may include a spool coupled to a motor 240, and the spool may receive and release a portion of a cable 230 in response to the operation of the motor 240. A position encoder coupled to the motor 240 may determine a position of the motor 240 or a component coupled to the motor 240. The actuator 200 may also include a load cell 260 and a spring 250, which may be arranged in series with the motor 240. This may improve torque tracking by improving disturbance rejection and making the exoskeleton actuator 200 more tolerant to misalignments. The motor 240, the load cell 260 and the spring 250 may be coupled to a second attachment portion arranged on one side of the joint. For example, they may be arranged just below the knee and attached to the second attachment portion such as, for example, a physical interface 270 that holds the components on the leg via frictional forces. The actuator 200 may also be implemented without the spring 250. The active components handling power and data (the motor 240 and the load cell 260) may lay flat against the leg to minimize protrusion. The exoskeleton actuator 200 may further include a pulley 220 arranged on the first attachment portion on the other side of the joint, which may also lay flat against the body to minimize protrusion. Arranging the components of the actuator 200 in such a way so as to minimize protrusion with respect to the leg may give the actuator overall a substantially low profile and make it comfortable to wear. Since the active components are arranged on one side of the joint with only the passive pulley 220 on the other, the distal mass may be reduced, which has larger penalties for metabolic cost of transport.

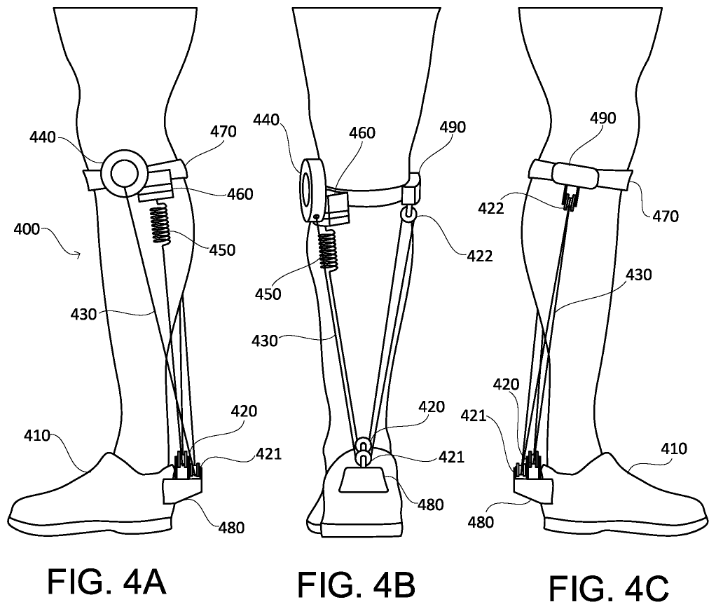

The pulley 220 may be attached to a shoe 210 by a hinge that allows for free movement of the pulley 220 with respect to the hinge, or the pulley 220 may be directly attached to the shoe 210. The attachment may consist of a relatively stiff component so as to minimize the deformation of the shoe in response to the applied force and maximize the effective mechanical work delivered to the ankle. The use of the pulley 220 on the far side of the joint may halve the required torque to be produced by the motor 240. Further, more than one guided member (i.e., pulley) may be coupled to the first attachment portion. For example, if two pulleys are provided, the cable may extend from one pulley to the other pulley, and form a loop around each pulley. In this way, the required torque to be provided by the motor 240 may be quartered. An example implementation with two pulleys is described in more detail below with reference to FIGS. 4A, 4B and 4C.

The exoskeleton actuator 200 may further include the cable 230 that is coupled to the second attachment portion at two locations on the second attachment portion, the cable extending to the guide member (i.e., the pulley 220) and forming a loop around the guide member. One of the two locations may be on the medial side of the body and the other on the lateral side of the body. The cable 230 may connect the motor 240, the load cell 260, the spring 250, arranged on one side of the joint, and the pulley 220 arranged on the other side of the joint. For example, the cable 230 may be coupled to the second attachment portion through the spring 250, or the load cell 260, or both. The motor 240 may increase tension in the cable 230 such that the loop of the cable pulls the first attachment portion toward the second attachment portion to actuate the joint. The cable 230 may be arranged in a triangular loop (i.e., the loop being V-shaped) with the apex at the pulley 220, which may allow for the joint to move freely out of the main plane of actuation. For example, ankle plantar flexion can be applied lifting the heel while not affecting the foot ability to move freely in the yah and roll axis. Further, due to the loop format of the cable 230 and the free-flowing nature of the pulley 220, the cable 230 can be easily keep taught with minimal active intervention and it can be housed in clothing integrated non-structural sleeves or protective tubing to avoid snagging.

In one example, the pulley 220 may be a rolling wheel pulley, such that the cable 230 is able to travel along with the rolling wheel. The axis of rotation of the pulley 220 may be substantially perpendicular to the axis of rotation of the joint. In another example, the pulley 220 may be a guide pulley with a channel, such that the cable is able to slide in the channel. The guide may be made using low friction plastic such as, but not limited to, Ultra High Molecular Weight Polyethylene plastic. The cable 230 may slide in the slippery plastic groove of the guide pulley 220.

Having a passive pulley transmitting force to the biological joint negates the need for mechanically powered artificial joints, which significantly minimizes the overall physicality of the exoskeleton actuator 200. The components of the exoskeleton actuator 200 described here may also be mirrored on both sides of the joint and may use the same motor 240 to achieve a double-acting function. For example, as well as having a guide member coupled to the back of the foot, a second guide member may be coupled to the front of the foot. Each guide member may have a separate cable looping around each guide member, while both cables may be connected to a single motor. The motor may increase the tension in the second cable coupled to the second guide member, while decreasing the tension in the first cable coupled to the first guide member, thereby inducing dorci flexion of the foot (flexion of the ankle such that the front of the foot is lifted up). By contrast, increasing the tension in the first cable and decreasing the tension in the second cable may instead induce plantar flexion of the foot (extension of the ankle such that the front of the foot moves down).

The exoskeleton actuator 200 may include a high-level controller, which may determine the course of action, and a low-level controller, which may determine how the course of action is achieved. The low-level controller may determine the desired force to be applied to the cable 230 at all times to keep it under constant tension. The load cell 260 may measure the torque due to movement. In response to the measurement, the low-level controller may send a signal to the motor 240 to turn either in a direction that would allow to take up slack of the cable 230 when the torque is too low, or in a direction that would allow to let out slack of the cable 230 when the torque is too high. In this way, the active components of the exoskeleton actuator 200 may form a closed control feedback loop. All implementations of the exoskeleton actuator 200 described herein may include this control system.

When the motor 240 engages and winds additional cable 230 around the spool, the cable 230 moves along the pulley 220 and tension increases. This tension in the cable 230 is transmitted to the foot as an upward force at the heel where the pulley is attached. The force translates into a torque of the ankle joint such that the heel moves upward and in the direction of the force and the toes of the foot move in the opposite direction.

FIGS. 3A and 3B illustrate the working principle of an ankle joint exoskeleton actuator 300 in more detail. A close up view of the exoskeleton actuator 300 shows a cable 330 arranged in a triangular loop with the apex at a pulley 320, the pulley 320 being attached to a lower attachment portion. The active components of the exoskeleton actuator 300 (not shown) may deliver tension to the cable 330, which may apply a force on the lower attachment portion in a substantially superior direction such that the ankle is plantar flexed (extended), as shown in FIG. 3B. The foot may be free to move in other directions even while the tension is applied. For example, the foot may be free to move side-to-side, wherein both the inversion of the ankle (rolling the sole of the foot to face medially) and the eversion of the ankle (rolling the sole of the foot to face laterally) may be freely applied. Further, the foot may be free to rotate about the ankle, such that the foot may be free to pivot medially (internal rotation) and laterally (external rotation). Since the pulley 320 is arranged at the back of the ankle, and the cable 330 is arranged in a triangular loop with the apex at the pulley 330, the total forces applied to the shin of the leg during actuation of the ankle joint are reduced, which makes the torque transmission overall more comfortable for the wearer.

FIGS. 4A, 4B and 4C show medial, rear, and lateral views, respectively, of a different implementation of an ankle joint exoskeleton actuator 400. This implementation differs from the one shown in FIG. 2 by having two lower pulleys and one upper pulley, instead of a single lower pulley. The pulleys also work together to actuate an ankle joint in such a way that the freedom of movement of the joint is preserved, but in this implementation the required torque to be delivered by the motor may be quartered.

This implementation includes the same components as those described above with respect to the implementation shown in FIG. 2. However, in this implementation, the motor 440, the load cell 460 and the spring 450 may be arranged on the medial side of the leg, while an upper pulley 422 may be attached to the physical interface 470 and arranged on the lateral side of the leg. This implementation may further include a pair of lower pulleys 420 and 421 arranged on the other side of the joint and attached to a shoe 410 via a stage 480, or each lower pulley 420 and 421 may be attached to the shoe 410 by a hinge, or any other appropriate means. The lower pulleys 420 and 421 may be arranged in parallel with each other. As described above in relation to the implementation of FIG. 2, the components of the exoskeleton actuator 400 may lie flat against the leg to minimize protrusion.

The exoskeleton actuator 400 shown in FIGS. 4A, 4B and 4C may further include a cable 430 connecting the motor 440, the load cell 460, the spring 450, and the upper pulley 422, arranged on the one side of the joint, and the lower pulleys 420 and 421 arranged on the other side of the joint. The cable 430 may be arranged in a double triangular loop with the first apex at the first lower pulley 420 and the second apex at the second lower pulley 421. The cable 430 may travel from the motor 440 to the first lower pulley 421, to the upper pulley 422, down to the second lower pulley 420 and up to the load cell 460. Since two lower pulleys 420 and 421 are provided, the required torque to be provided by the motor 440 may be quartered. However, more than two lower pulleys may also be included in the exoskeleton actuator 400. The ankle joint exoskeleton actuator 400 according to this implementation may maintain symmetry of force freedom of foot yaw and roll.

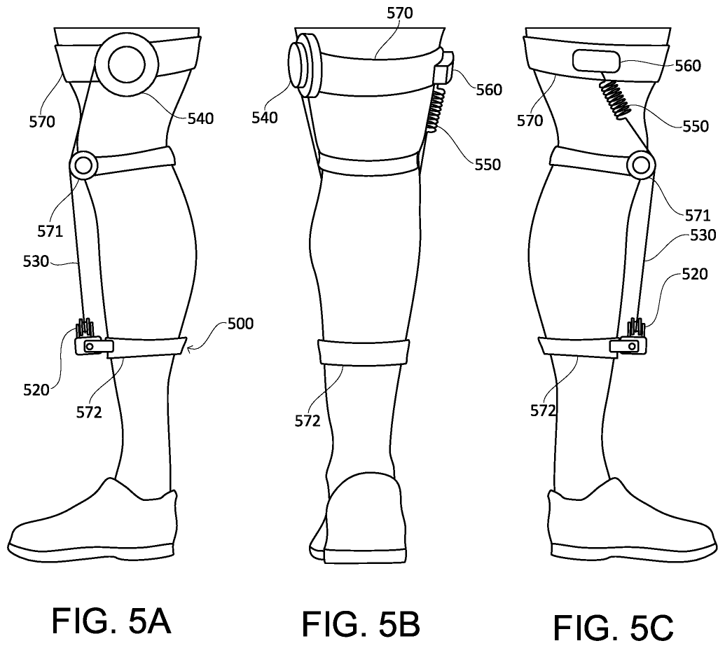

FIGS. 5A, 5B and 5C show medial, rear, and lateral views, respectively, of a knee joint exoskeleton actuator 500. The actuator 500 includes a similar arrangement of components as the ankle joint exoskeleton actuator 200 shown in FIG. 2, but in this implementation the pulley functions to actuate a knee joint instead.

The actuator 500 includes the same components as those described above in respect of the implementation of FIG. 2. However, this implementation includes a motor 540, a load cell 560 and a spring 550 all attached to a physical interface 570 that holds the components on the leg via frictional forces and is arranged above the knee. The exoskeleton actuator 500 may further include a pulley 520 attached to a second physical interface 572 which may be arranged below the knee. More than one pulley may be provided on the second physical interface 572, similarly to the implementation described above with reference to FIG. 4. The exoskeleton actuator 500 may also include a retainer plate 571 arranged across the knee joint. In joints with high degree of flexion, such as the knee , the retainer plate 571 is arranged at the front of the joint such that it keeps the cable 530 at the front of the leg and stops it from snagging.

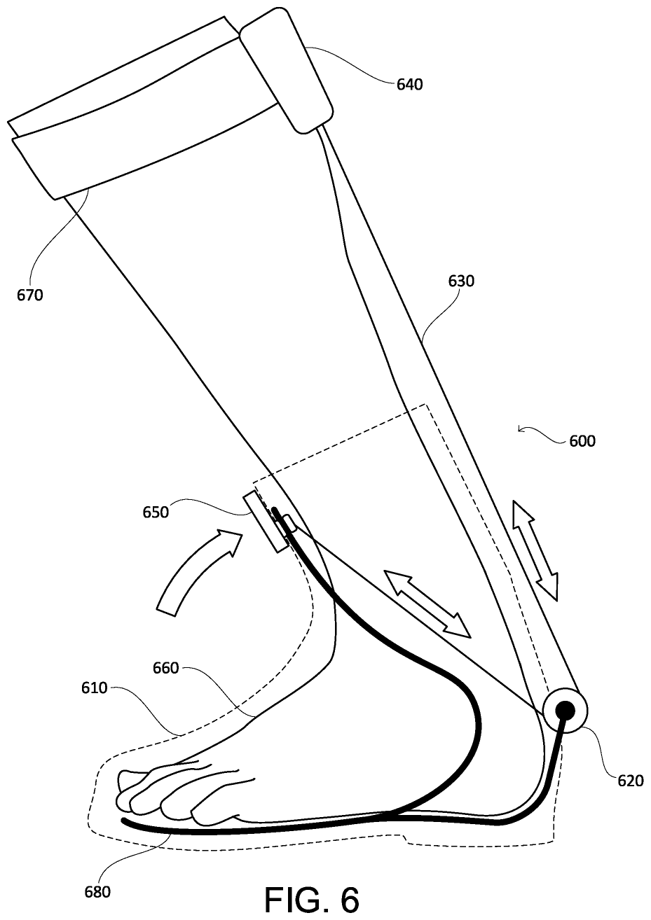

FIG. 6 shows a lateral view of a different implementation of an ankle joint exoskeleton actuator 600. This implementation is different from the implementation shown in FIG. 2 in that one end of a cable may be attached to a flexure that forms a part of a shoe, as opposed to both ends of the cable being attached to a physical interface positioned up the leg. This implementation also differs from the one of FIG. 2 in terms of the process of force delivery to the foot, since a tension in the cable may transform into compression of the flexure in such a way that the resultant force is driven to the ground and the foot rotates about a virtual pivot point generated by the flexure, as opposed to about the ankle joint itself.

This implementation may include a motor, a load cell, and a spring, collectively indicated by reference numeral 640, and they may be attached to a physical interface 670 that holds these elements on the body via frictional forces. The physical interface 670 may be mounted on, for example, the leg, the thigh, or the waist, which may allow for more configuration flexibility and less distal mass. The exoskeleton actuator 600 may include a sole element 680 which may be integrated as part of a shoe 610. The sole element 680 may be made of carbon fiber, or carbon fiber containing composite, or any other suitably rigid material. A pulley 620 may be attached to the sole element 680, such that its axis of rotation is perpendicular to the length of the foot 660. However, more than one pulley may also be provided.

The exoskeleton actuator 600 may include a cable 630 attached to the top of the shoe 610 by an attachment 650 and travelling from the attachment to the pulley 620 and towards the active components 640. In one example, the pulley 620 may be a rolling wheel pulley, such that the cable 630 is able to travel along with the rolling wheel. In another example, the pulley 620 may be a guide pulley with a groove, such that the cable 630 is able to slide in the groove. The guide may be made using low friction plastic such as, but not limited to, Ultra High Molecular Weight Polyethylene plastic. The cable 630 may slide in the slippery plastic groove of the guide pulley 620. The exoskeleton actuator 600 may further include a flexure 681 attached to the sole element 680 and made of a suitably flexible material. The flexure 681 may be integrated as part of the shoe 610. Imparting tension to the cable 630 via the active components 640 may cause the cable 630 to pull on the attachment point 650 and against the flexure 681 to bend it against the sole element 680 in such a way that the torque is transmitted to the ankle joint via a virtual pivot point generated by the flexure 681. The tension of the cable 630 and the resultant torque of the ankle joint are shown by the arrows in FIG.6. Due to the flexible nature of the flexure 681 and the components structurally surrounding the ankle joint and having the capability to be integrated into the shoe 610, this implementation has a substantially low profile, is comfortable, and is able to preserve the freedom of movement of the joint in all directions.

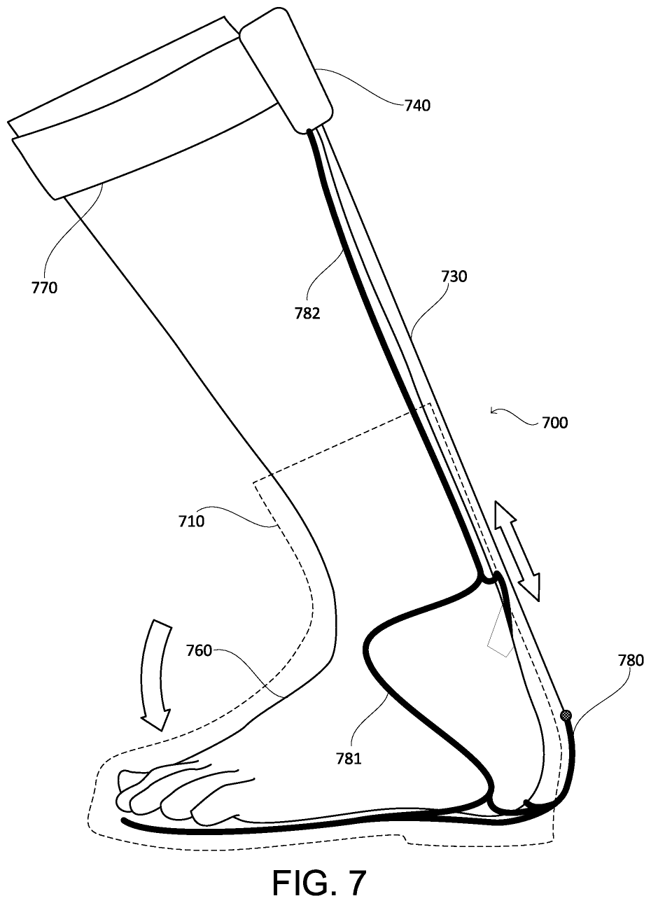

FIG. 7 shows a lateral view of a different implementation of an ankle joint exoskeleton actuator 700. Similarly to the implementation of FIG. 6, this implementation includes a flexure. However, in this implementation, a cable is attached to a sole element, instead of a pulley, and the actuator further includes a stiff vertical strut that helps to transform a tension of the cable into torque of the foot about a virtual pivot point generated by the flexure.

This implementation may include a motor, a load cell, and a spring, collectively indicated by reference numeral 740, and they may be attached to a physical interface 770 that holds these elements on the body via frictional forces. The physical interface 770 may be mounted on, for example, the thigh, or the waist, which may allow for more configuration flexibility and less distal mass. The exoskeleton actuator 700 may include a sole element 780 which may be integrated as part of a shoe 710. The sole element 780 may be made of carbon fiber, or carbon fiber containing composite, or any other suitably rigid material. The exoskeleton actuator 700 may further include a cable 730 attached to the sole element 780 and travelling from the sole element 780 towards the active components 740, and a flexure 781 attached to the sole element 780 and made of a suitably flexible material. The flexure 781 may be integrated as part of the shoe 710. The flexure 781 may be designed in such a way so as to have virtual pivot point coincident with the ankle joint, such that when the cable 730 is pulled, the actuation of the ankle joint does not induce uncomfortable shear forces to the skin. The flexure 781 may act as two separate rigid links connected by a bearing coincident with the ankle joint, and as a spring crossing that joint and acting in parallel to the ankle. The advantage of this implementation is that by using the flexure 781, the aforementioned components are reduced to a single, slim, and lightweight piece. The exoskeleton actuator 700 may further include a stiff vertical strut 782 attached to the flexure 781.

Imparting tension to the cable 730 via the active components 740 may cause the cable 730 to pull on the sole element 780, and the tension of the cable 730 may cause the stiff vertical strut 782 to react in response pushing on the flexure 781 and causing it to flex against the sole element 780, in such a way that the torque is transmitted to the ankle joint via a virtual pivot point generated by the flexure 781. The tension of the cable 730 and the resultant torque of the ankle joint are shown by the arrows in FIG. 7. Due to the flexible nature of the flexure 781 and the components structurally surrounding the ankle joint and having the capability to be integrated into the shoe 710, this implementation has a substantially low profile, is comfortable, and is able to preserve the freedom of movement of the joint in all directions.

The controller and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

While this document contains many specific implementation details, these should not be construed as limitations on the scope of any inventions or of what may be claimed, but rather as descriptions of features specific to particular embodiments of particular inventions.

Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Thus, particular embodiments of the subject matter have been described. Other embodiments are within the scope of the following claims.

1. An assistive device configured to assist actuation of a joint of a body of a wearer of the assistive device, the assistive device comprising:
a first attachment portion configured to be placed on a first portion of the wearer's body;
a guide member coupled to the first attachment portion;
a second attachment portion configured to be placed on a second portion of the wearer's body;
a motor coupled to the second attachment portion; and
a cable that is coupled to the second attachment portion at two locations on the second attachment portion, the cable extending to the guide member and forming a loop around the guide member, the motor being configured to increase tension in the cable such that the loop of the cable pulls the first attachment portion toward the second attachment portion to actuate the joint.

2. The assistive device of claim 1, wherein the guide member is a pulley.

3. The assistive device of claim 2, wherein the pulley has an axis of rotation that is substantially perpendicular to an axis of rotation of the joint.

4. The assistive device of claim 1, wherein the guide member comprises a channel and the cable is configured to slide through the channel.

5. The assistive device of claim 1, wherein the loop of the cable is substantially V-shaped.

6. The assistive device of claim 1, further comprising a spring coupled to the cable, the cable being coupled to the second attachment portion through the spring.

7. The assistive device of claim 1, further comprising a load sensor coupled to the cable, the cable being coupled to the second attachment portion through the load sensor.

8. The assistive device of claim 1, further comprising a spool coupled to the motor, the spool being configured to receive and release a portion of the cable in response to the operation of the motor.

9. The assistive device of claim 1, further comprising a position encoder configured to determine a position of the motor or a component coupled to the motor.

10. The assistive device of claim 1, wherein the assistive device is configured to actuate an ankle joint of the wearer.

11. The assistive device of claim 1, wherein the assistive device is configured to actuate a knee joint of the wearer.

12. The assistive device of claim 1, wherein the two locations on the second attachment portion are on opposite sides of the second portion of the body, and wherein a first location of the two locations is on the medial side of the second portion of the body and a second location of the two locations is on the lateral side of the second portion of the body.

13. The assistive device of claim 1, wherein the first attachment portion and the second attachment portion are configured to be placed on opposite sides of the joint.

14. The assistive device of claim 1, further comprising a second guide member coupled to the first attachment portion, and wherein the cable extends from the first guide member to the second guide member and forms a loop around the second guide member.

15. An assistive device configured to assist actuation of an ankle of a wearer of the assistive device, the assistive device comprising:
a lower attachment portion configured to be coupled with a foot of the wearer;
a pulley coupled to the lower attachment portion;
an upper attachment portion configured to be placed on a leg of the wearer;
a motor coupled to the upper attachment portion; and
a cable that is coupled to the upper attachment portion at two locations on the upper attachment portion, the cable extending around the pulley to form a loop around the pulley, the motor being configured to increase tension in the cable such that the loop of the cable pulls the lower attachment portion toward the upper attachment portion to actuate the ankle.

16. The assistive device of claim 15, wherein the upper attachment portion is configured to be placed on the leg below the knee.

17. The assistive device of claim 15, wherein the two locations on the upper attachment portion are on opposite sides of the leg, and wherein a first location of the two locations is on the medial side of the leg and a second location of the two locations is on the lateral side of the leg.

18. The assistive device of claim 15, wherein the cable is configured to exert a force on the lower attachment portion in a substantially superior direction, such that the ankle is flexed without restricting inversion and eversion of the foot.

19. The assistive device of claim 15, wherein the cable is configured to exert a force on the lower attachment portion in a substantially superior direction, such that the ankle is flexed without restricting medial and lateral rotation of the ankle.

20. The assistive device of claim 15, further comprising a second pulley coupled to the lower attachment portion, and wherein the cable extends from the first pulley to the second pulley and forms a loop around the second pulley.
